(19) United States
(12) Patent Application Publication
(10) Pub. No.: US 2020/0175609 A1
(43) Pub. Date: Jun. 4, 2020

(54) AUGMENTED REALITY BADGES

(71) Applicant: International Business Machines Corporation, Armonk, NY (US)

(72) Inventors: Clea Anne Zolotow, Key West, FL (US); Andrew Paul Barnes, Greystones (IE); Maeve O'Reilly, Wicklow (IE); Jørgen Egbert Floes, Stenløse (DK); Kim A. Eckert, Austin, TX (US); Anthony Hunt, Hopewell Junction, NY (US)

(21) Appl. No.: 16/205,923

(22) Filed: Nov. 30, 2018

(51) Int. Cl. G06Q 50/00; G06T 11/60

(52) U.S. Cl. CPC G06Q 50/01; G06T 11/60

(57) ABSTRACT

A method, system and computer readable program storage device for using augmented reality. In an embodiment, the method comprises determining one or more characteristics of a plurality of users, and determining whether a first and a second user of the plurality of users are in proximity to each other. Responsive to determining that the first and second users are in proximity to each other, determining defined information about the second user is determined; and responsive to determining the defined information of the second user, the defined information is displayed to the first user via an augmented reality display over a security badge associated with the second user. In embodiments, the determining one or more characteristics of a plurality of users includes determining one or more characteristics of the plurality of users based on location, social media, or work profiles.

### BACKGROUND

This invention generally relates to augmented reality displays, and more specifically, the invention relates to displaying information about a person via an augmented reality display over a security badge associated with the person.

In many corporations today, people can get digital or electronic badges for their education, such as Open Systems Group certification, or by taking a certain number of classes in an on-line university or in a classroom and passing a test. These badges are collected on a website, in a database, or another information-collecting facility so the corporation and other employees can see the badges and the competency areas that employees and co-workers have obtained.

Augmented Reality (AR) is a live direct or indirect view of a physical, real-world environment whose elements are augmented by computer generated or extracted sensory input such as sound, video, graphic, haptics or GPS data. Augmented reality is used in order to enhance the experienced environment or situations and to offer enriched experiences. Augmentation techniques are typically performed in real time and in semantic context with environmental elements such as overlaying supplemental information. With the help of AR techniques, the information about the surrounding real world of a user becomes interactive and digitally manipulable.

### SUMMARY

Embodiments of the invention provide a method, system and computer readable program storage device for displaying information about a person via an augmented reality display. In an embodiment, the method comprises determining one or more characteristics of a plurality of users, and determining whether a first and a second user of the plurality of users are in proximity to each other. Responsive to determining that the first and second users are in proximity to each other, determining defined information about the second user is determined; and responsive to determining the defined information of the second user, the defined information is displayed to the first user via an augmented reality display over a security badge associated with the second user.

Embodiments of the invention allow people to see physically other people's credentials and badges.

Embodiments of the invention may be used to do a seek on a specific or generalized skill set or other attribute at, for example, the lunch table or an informal meeting or gathering.

### BRIEF DESCRIPTION OF THE SEVERAL VIEWS OF THE DRAWINGS

FIG. 1 illustrates an embodiment of the invention.

FIG. 2 is a flow chart showing a method of an embodiment of the invention.

FIG. 3 illustrates the use of cognitive analysis to determine a person's skill from social media.

FIG. 4 shows a list of job roles and related information that may be used to identify a person's skill.

FIG. 5 shows another example of the use of cognitive analysis for identifying skills of a person.

FIG. 6 shows a computer network environment that may be used to implement embodiments of the invention.

FIG. 7 depicts a processing unit that may be used in the system of FIG. 1 or the computer network environment of FIG. 6.

### DETAILED DESCRIPTION

Embodiments of the invention alert people who are interested in finding other people with specific skills, interests, or other attributes, that such a person is nearby. In embodiments of the invention, this is done by displaying information about a person via an augmented reality display over a security badge associated with the person.

As discussed above, in many corporations today, people can get digital or electronic badges for their education, such as Open Systems Group certification, or by taking a certain number of classes in an on-line university or in a classroom and passing a test. Digital badges are validated indicators of accomplishments, skills, qualities, or interests. Typically, each badge is associated with an image and information about the badge, its recipient, and the issuer. This information may be packaged within an image file that can be displayed on-line or via social networks.

These badges are collected on a website or other information repository so the corporation and other employees can see the badges and the competency areas that employees and co-workers have obtained. However, unless a person is at their desk or looking up the certification website on their cell phone, it is not apparent to this person when in the lunch line, for example, that the person in front of them is, for example, a Senior Certified Big Data Architect, which is exactly the skill set the former person is looking for to finish a project. The certification website may be the only way at such a time to see people's badges. People may include badges on their signature lines in emails, but usually it is just a select number of badges and including them on the signature line is optional and not available in real time as people are walking around.

Embodiments of this invention utilize augmented reality to animate the badges around a person in order to show their skill set without relying on a computer. In this way, people can know what their co-workers competencies or other attributes are without looking up the certification website or other information-holding facility. This also allows people to see the competency levels of many other people at the same time, rather than looking up those competency levels one by one, as is the case today.

In embodiments of the invention, users can opt-in/opt-out of the system. One way to do this, as an example, is to restrict certain features of the application by limiting permissions in the phone. As another example, the user can limit the functions of the phone utilizing “LicenseInformation” within the application. In this example, there is an interface so the consumer would pick the type of license they wanted—full, limited, etc.

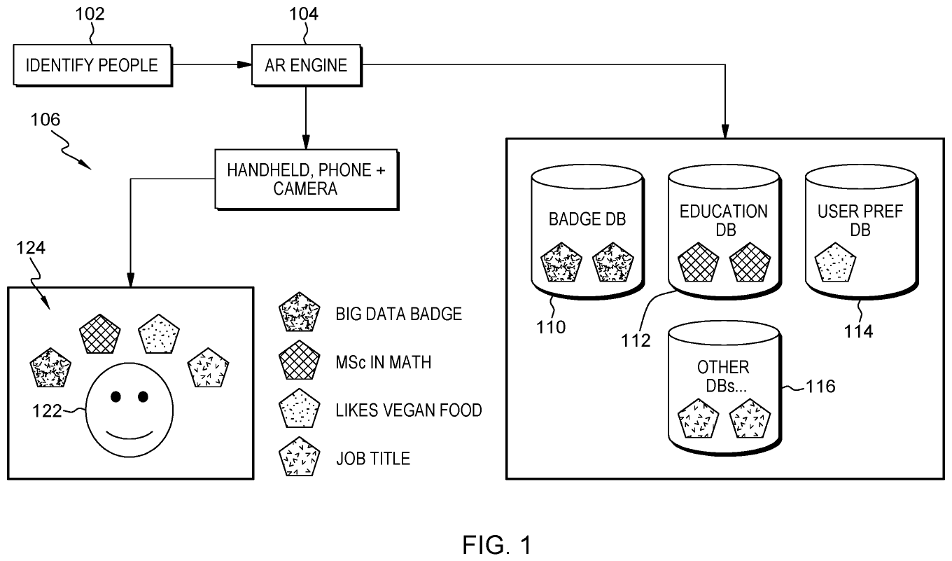

FIG. 1 generally illustrates an embodiment of the invention. In this embodiment, the main components are: Identifying People 102, Augmented Reality Engine 104, and Handheld/Mobile device user interface 106. FIG. 1 also shows a group of databases. One database 110 may store badges, a second database 112 may store information identifying educational accomplishments or achievements, a third database 114 may store user preferences data. Other databases, represented at 116, may also be queried in embodiments of the invention.

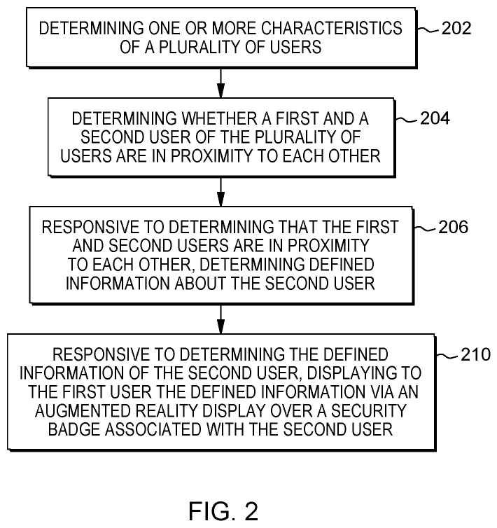

FIG. 2 is a flow chart showing a method of an embodiment of the invention. This method comprises, at 202, determining one or more characteristics of a plurality of users, and at 204, determining whether a first and a second user of the plurality of users are in proximity to each other. In embodiments of the invention, the characteristics of the user are determined via the users based on location, social media, or work profiles. For instance, if there is a location such as a trade show, the characteristics may be determined by the data elements entered into the trade show profile. Other characteristics can be developed from feeds from social media. Work profiles (i.e., number of badges and number of patents) can be used. In embodiments of the invention, this is done by either a direct link (i.e., at the trade show or work) or a learning engine getting key words from social media. Proximity location, in embodiments of the invention, is determined via GPS.

At 206, responsive to determining that the first and second users are in proximity to each other, defined information about the second user is determined; and at 210, responsive to determining the defined information of the second user, the defined information is displayed to the first user via an augmented reality display over a security badge associated with the second user. The defined information about the second user can be determined by the first user looking for someone, for example, able to code in javascript. Then, the user would set that function to look for that specific skill.

As an example, two employees, A and B, may have similar job functions; and employee A has a queue that would permit him to take on a case from the first user, but employee B is more senior and has more experience with the type of problem the first user needs help with. In embodiments of the invention, the issue of which employee to select, A vs. B, is resolved from a database that contains that information, i.e., employee seniority, queue depth, a “looking for more work” tag.

With reference to FIGS. 1 and 2, in embodiments of the invention, the handheld or mobile device user interface 106 is used to show people around a user with badges the user may be interested in. In embodiments of the invention, the user looks at their device and sees other people 122 with badges 124 around their heads, giving a visual cue that close by there may be a person they may want to make contact with to discuss a project or interest.

Identifying people is the ability to recognize who a person is as well as their skill set. After a person is identified, their badges are identified, filtered for what is relevant to a user's current interests or needs, or as specifically defined by the user as a skill he or she currently needs. In embodiments of the invention, the filtering is a non-specific filtering, and can be two databases seeing what is in common. For example, in SAS, the data in the database may be, user1(in=A) and user2(in=b), where a=b. this can be enhanced where a and b are metasets of skills (i.e., “code” not just “Javascript”).

In embodiments of the invention, people may be identified in any suitable way, and many procedures are well known for identifying people. Various implementations are possible to identify people, such as Quick Response (QR) codes on security badges, an app that is on a cell phone, facial recognition, or other trait recognition such as gait recognition.

In embodiments of the invention, identification of a person's badges may be done by providing all participating users with an app installed on a cell phone or mobile computing device of theirs, that allows other users of the app to see their badges. In order to obtain optimal results, users would always have their cell phones or mobile devices. Within corporate contexts, and many other contexts, people often or usually have their cell phones or mobile devices; they could have a corporate app on a corporate device.

In another approach, participating users have a QR code or radio frequency ID (RFID) on their work badges which can be identified by a mobile device scanning at close range. Alternatively, facial (and related traits such as gait) recognition may be used to identify a person, and then a badge database can be queried.

The Augmented Reality Engine 104 is used to show badges of a person of interest. The Augmented Reality Engine 104 also provides for Pre-Selection. The Engine enables users to explicitly state what skill set or interests they are looking for. For example, a new vegan may be interested in meeting other vegans. A person working on predictive maintenance models may be interested in meeting people with skills in statistics or who specifically need help with a relevant technology.

Augmented Reality Engine 104 may be implemented on any suitable processor or processing system, including a computer, a computer server, a workstation computer, or laptop computer. In some embodiments, the Augmented Reality Engine 104 may be implemented on a smart phone or a mobile computing device such as a tablet.

With employees earning and being recognized with a variety of badges (tens or hundreds), the level of detail could be overwhelming, making it difficult to discern relevant badges. Using cognitive analysis, embodiments of this invention analyze tags from, for example, social media, and information from emails sent and received, to identify technologies (e.g., through key words) which are most relevant or topical. Using this output, relevant badges are highlighted in the first instance. Then, using visual cues, badges of most relevance will be highlighted—identifying people of specific note or importance.

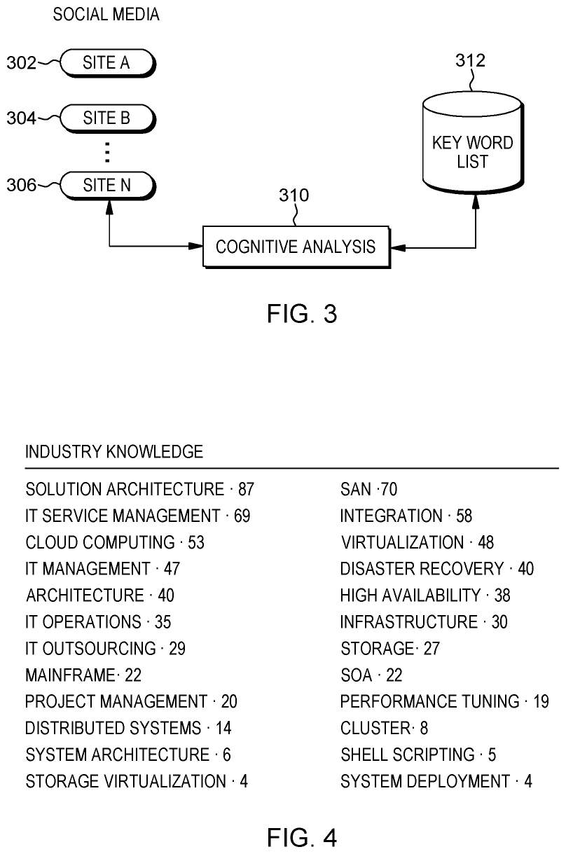

FIG. 3 illustrates the use of cognitive analysis to determine a person's skill from social media. Feeds from social media sites 302, 304, 306 can be pulled into a cognitive analysis 310 utilizing a keyword list 312. This list can contain generally utilized items such as reading, baking, etc. for hobbies, and computers or health as a skill, as found in social media feeds such as from Facebook and Twitter. This cognitive analysis 310 may be comprised of generally available natural language processing based on keywords. Any suitable natural language processing may be used in embodiments of the invention, and a number of suitable natural language processing systems are known by and are available to those of ordinary skill in the art.

Embodiments of the invention may also identify skills from a work profile. These profiles may list job roles and specialties and job descriptions. These work profiles are often comparatively easy to analyze. Cognitive analysis may be used to analyze these lists; however, there may not be a need for, or a need for much, cognitive analysis of these lists.

Other web sites, such as Linkedin, list job roles and related information, as for example shown in FIG. 4, in a clear, simple way, and this information also may be relatively easy to analyze to identify a person's skills.

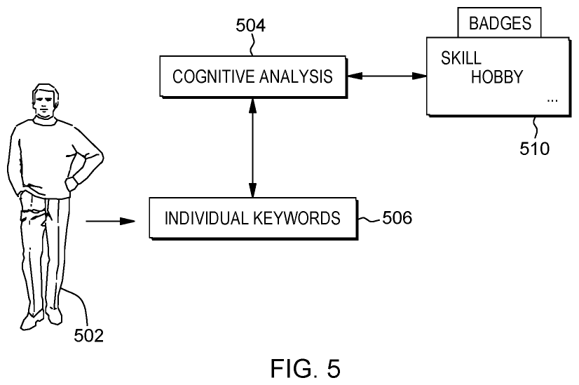

The implementation of the cognitive analysis, in embodiments of the invention, depends on what another person is looking for—and their keywords. For example, with reference to FIG. 5, a person 502 may approach a group that desires skills in a particular enterprise software. Cognitive analysis 504 uses a list of keywords 506 to search through a data source 510 that identifies this person's badges, skills and hobbies. The person is known (via a corporate profile, or a profile on a publically available Web site) to have middleware skills. The cognitive analysis can translate the enterprise software skills into middleware skills knowing that they are the same skill.

The above-discussed badge analysis can be extended to help identify people of interest to an individual through a combination of pre-selection or through cognitive analysis. For instance, a user may input “I want to be prompted when the CEO walks up to me,” or “I need help with a middleware application,” or “I want to be prompted when the Director responsible for the project I'm working on walks up to me.”

Using a combination of a pre-tagging system (pre-store specific information) and cognitive analysis, the user could also be prompted with some question and information about the person they are meeting to ease or facilitate the conversation, such as “Do you have an advanced Badge in MQ?”.

A mobile computing device, such as may be used in the system of FIG. 1, has a limited display surface, and embodiments of the invention may prioritize which information gets displayed first. How this is done depends on the implementation of the invention. In an embodiment, work information would come first. Also, embodiments of the invention include an ability for a person to filter their results to display selected results. The cognitive engine, if utilized in these embodiments, could determine what was the most important to people, but it is usually the context of the area (i.e., work vs. hobbies) that would be the most important.

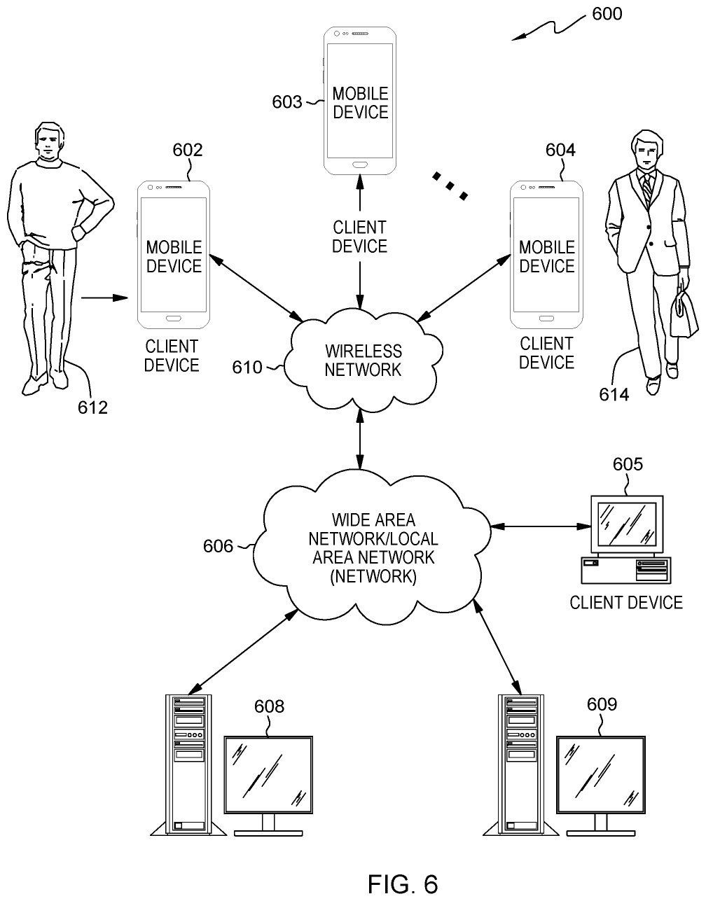

FIG. 6 shows components of an exemplary environment 600 in which the invention may be practiced. Not all the illustrated components may be required to practice the invention, and variations in the arrangement and type of the components may be made without departing from the spirit or scope of the invention. As shown, exemplary environment 600 of FIG. 6 includes local area networks (“LANs”)/wide area network 606, wireless network 610, mobile devices 602-604, client device 605, and servers 608-609. FIG. 6 also shows a person 612 who is looking for another person having a particular skill, and a person 614 who has a digital badge showing that he has this skill.

Generally, mobile devices 602-604 may include virtually any portable computing device that is capable of receiving and sending a message over a network, such as networks 606 and wireless network 610. Such devices include portable devices, such as cellular telephones and smart phones, and wearable devices such as smart watches, smart glasses and smart lenses. Mobile devices may also include display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 202-204 typically range widely in terms of capabilities and features.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 602-604 may each receive messages sent from servers 208-209, from one of the other mobile devices 602-604, or even from another computing device. Mobile devices 602-604 may also send messages to one of AS 608-609, to other mobile devices, or to client device 605, or the like. Mobile devices 602-604 may also communicate with non-mobile client devices, such as client device 205, or the like.

Wireless network 610 is configured to couple mobile devices 602-604 and its components with network 606. Wireless network 610 may include any of a variety of wireless sub-networks that may further overlay stand-alone ad-hoc networks, and the like, to provide an infrastructure-oriented connection for mobile devices 602-604. Such sub-networks may include mesh networks, Wireless LAN (WLAN) networks, cellular networks, and the like.

Network 606 is enabled to employ any form of computer readable media for communicating information from one electronic device to another. Also, network 206 can include the Internet in addition to local area networks (LANs), wide area networks (WANs), direct connections, such as through a universal serial bus (USB) port, other forms of computer-readable media, or any combination thereof.

Servers 608-609 include virtually any device that may be configured to provide an application service. Such application services or simply applications include, but are not limited to, email applications, search applications, video applications, audio applications, graphic applications, social networking applications, text message applications, or the like. In one embodiment, servers 608-609 may operate as web servers. However, servers 608-609 are not limited to web servers.

Those of ordinary skill in the art will appreciate that the architecture and hardware depicted in FIG. 6 may vary.

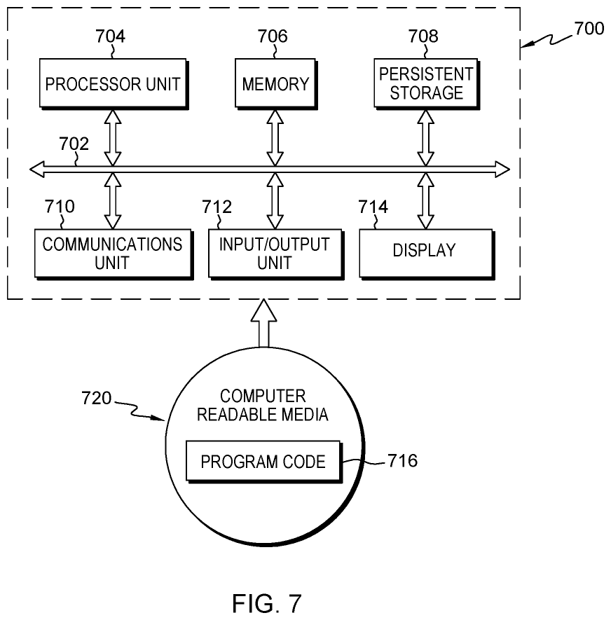

FIG. 7 depicts a diagram of a data processing system 700. Data processing system 700 is an example of a computer that can be used in the system of FIG. 1 or the computer network of FIG. 6. In this illustrative example, data processing system 700 includes communications fabric 702, which provides communications between processor unit 704, memory 706, persistent storage 708, communications unit 710, input/output (I/O) unit 712, and display 714.

Processor unit 704 serves to execute instructions for software that may be loaded into memory 706. Processor unit 704 may be a set of one or more processors or may be a multi-processor core, depending on the particular implementation. Further, processor unit 704 may be implemented using one or more heterogeneous processor systems, or, as another illustrative example, processor unit 704 may be a symmetric multi-processor system containing multiple processors of the same type.

Memory 706 and persistent storage 708 are examples of storage devices. Memory 706, in these examples, may be, for example, a random access memory, or any other suitable volatile or non-volatile storage device. Persistent storage 708 may take various forms, depending on the particular implementation. For example, persistent storage 708 may contain one or more components or devices. For example, persistent storage 708 may be a hard drive, a flash memory, a rewritable optical disk, a rewritable magnetic tape, or some combination of the above.

Communications unit 710, in these examples, provides for communication with other data processing systems or devices. In these examples, communications unit 710 is a network interface card. Communications unit 710 may provide communications through the use of either or both physical and wireless communications links.

Input/output unit 712 allows for the input and output of data with other devices that may be connected to data processing system 700. For example, input/output unit 712 may provide a connection for user input through a keyboard, a mouse, and/or some other suitable input device. The input/output unit may also provide access to external program code 716 stored on a computer readable media 620. Further, input/output unit 712 may send output to a printer. Display 714 provides a mechanism to display information to a user.

Those of ordinary skill in the art will appreciate that the architecture and hardware depicted in FIG. 7 may vary.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A computer-implemented method comprising:
determining, by one or more processors, one or more characteristics of a plurality of users;
determining, by the one or more processors, whether a first and a second user of the plurality of users are in proximity to each other;
responsive to determining that the first and second users are in proximity to each other, determining, by the one or more processors, defined information about the second user; and
responsive to determining the defined information of the second user, displaying, by the one or more processors, to the first user the defined information via an augmented reality display over a security badge associated with the second user.

2. The method according to claim 1, wherein the determining one or more characteristics of a plurality of users includes determining one or more characteristics of the plurality of users based on location, social media, or work profiles.

3. The method according to claim 1, wherein the determined characteristic include one or more of a skill, a title, a job function, or experience.

4. The method according to claim 1, wherein the defined information includes one or more of a desired skill, experience, a job title, an importance indicator, or a shared interest.

5. The method according to claim 1, wherein the displaying the defined information via an augmented reality display over a security badge associated with the second user includes animating the security badge around a representation of the second person to show that the second person has a particular skill.

6. The method according to claim 1, wherein the displaying the defined information via an augmented reality display over a security badge associated with the second user includes displaying the defined information on a mobile communications device of the first user.

7. The method according to claim 1, wherein the determining defined information about the second user includes:
identifying the second user; and
searching through one or more specified databases for security badges associated with the second user.

8. The method according to claim 1, wherein the determining defined information about the second user includes searching, via a mobile communications devices of the second user, for security badges associated with the second user.

9. The method according to claim 1, wherein the determining defined information about the second user includes:
the first user identifying a specified characteristic; and
searching through one or more sources of information for information showing that the second use has the specified characteristic.

10. The method according to claim 1, wherein the determining defined information about a second user includes using a cognitive analysis to determine a skill of the second user from social media.

11. A system comprising:
a computer network comprising:
a memory; and
one or more processing units operatively connected to the memory to transmit data to and to receive data from the memory, the one or more processor units configured for
determining one or more characteristics of a plurality of users;
determining whether a first and a second user of the plurality of users are in proximity to each other;
responsive to determining that the first and second users are in proximity to each other, determining defined information about the second user; and
responsive to determining the defined information of the second user, displaying to the first user the defined information via an augmented reality display over a security badge associated with the second user.

12. The system according to claim 11, wherein the determining one or more characteristics of a plurality of users includes determining one or more characteristics of the plurality of users based on location, social media, or work profiles.

13. The system according to claim 11, wherein the displaying the defined information via an augmented reality display over a security badge associated with the second user includes animating the security badge around a representation of the second person to show that the second person has a particular skill.

14. The system according to claim 11, wherein the determining defined information about the second user includes:
identifying the second user; and
searching through one or more specified databases for security badges associated with the second user.

15. The system according to claim 11, wherein the determining defined information of the second user includes searching, via a mobile communications devices of the second user, for security badges associated with the second user.

16. A computer readable program storage device comprising:
a computer readable storage medium having program instructions embodied therein, the program instructions executable by a computer to cause the computer to perform the method of:
determining one or more characteristics of a plurality of users;
determining whether a first and a second user of the plurality of users are in proximity to each other;
responsive to determining that the first and second users are in proximity to each other, determining defined information about the second; and
responsive to determining the defined information of the second user, displaying to the first user the defined information via an augmented reality display over a security badge associated with the second user.

17. The computer readable storage device according to claim 16, wherein the determining one or more characteristics of a plurality of users includes determining one or more characteristics of the plurality of users based on location, social media, or work profiles.

18. The computer readable storage device according to claim 16, wherein the displaying the defined information via an augmented reality display over a security badge associated with the second user includes animating the security badge around a representation of the second person to show that the second person has a particular skill.

19. The computer readable storage device according to claim 16, wherein the determining defined information about the second user includes:
identifying the second user; and
searching through one or more specified databases for security badges associated with the second user.

20. The computer readable storage device according to claim 16, wherein the determining defined information of the second user includes searching, via a mobile communications devices of the second user, for security badges associated with the second user.
